(19) United States
(12) Patent Application Publication
(10) Pub. No.: US 2008/0218077 A1
(43) Pub. Date: Sep. 11, 2008

(54) DISCHARGE LIGHT-EMITTING DEVICE

(75) Inventors: Tadashi SAKAI, Kanagawa (JP); Tomio ONO, Kanagawa (JP); Naoshi SAKUMA, Kanagawa (JP); Hiroaki YOSHIDA, Kanagawa (JP); Mariko SUZUKI, Kanagawa (JP)

Correspondence Address: OBLON, SPIVAK, MCCLELLAND MAIER & NEUSTADT, P.C., 1940 DUKE STREET, ALEXANDRIA, VA, 22314, US

(73) Assignee: Kabushiki Kaisha Toshiba, Tokyo (JP)

(21) Appl. No.: 11/850,416

(22) Filed: Sep. 5, 2007

(30) Foreign Application Priority Data
Sep. 15, 2006 (JP) 2006-251810

(51) Int. Cl. H01J 1/62

(52) U.S. Cl. 313/512

(57) ABSTRACT

A discharge light-emitting device includes a chamber that encapsulates a discharge gas and has a light permeable portion; and at least a pair of electrodes that are arranged in the chamber and are made of a wide-gap semiconductor, wherein the pair of electrodes are connected to each other and at least a portion where the electrodes are connected to each other is formed into a narrow portion.

### CROSS-REFERENCE TO RELATED APPLICATIONS

This application is based upon and claims the benefit of priority from the prior Japanese Patent Application No. 2006-251810, filed on Sep. 15, 2006; the entire contents of which are incorporated herein by reference.

### BACKGROUND OF THE INVENTION

1. Field of the Invention

The present invention relates to a discharge light-emitting device.

2. Description of the Related Art

Discharge light-emitting devices such as discharge lamps have been used for illumination and become a mainstream of illumination light sources, recently. The discharge lamps have been developed and produced to have different forms and structures for many purposes. For example, JP-A 2003-92086 (KOKAI) discloses a noble-gas discharge lamp that includes at least a rear surface substrate for defining a discharge chamber, a translucent front surface substrate, a frame of the front surface substrate, a noble gas encapsulated in the discharge chamber, a pair of electrodes for generating dielectric barrier discharge in the discharge chamber, a dielectric film formed on the electrodes, and a fluorescent film formed on the dielectric film.

Among the discharge lamps, market share of high-performance, high-intensity discharge (HID) lamps using a high atmospheric pressure has increased. The HID lamps have rich color rendering properties and a high lightening efficiency.

However, the HID lamps require a high voltage in a start of discharge because a high pressure gas is filled in the HID lamps. Furthermore, the HID lamps operate in a low-voltage and high-current circumstance after the start of discharge. Therefore, a driving circuit of the HID lamps is required to meat the various operational conditions from the high-voltage and low-current circumstance to the low-voltage and high-current circumstance, which loads a burden on the HID lamps.

The discharge lamps, more particularly the HID lamps, require tough operational conditions, that is, to meat the high voltage at the start of discharge and the low-voltage and high-current at the stable operation period, which makes the driving control complicated.

### SUMMARY OF THE INVENTION

According to one aspect of the present invention, a discharge light-emitting device includes a chamber that encapsulates a discharge gas and has a light permeable portion; and at least a pair of electrodes that are arranged in the chamber and are made of a wide-gap semiconductor, wherein the pair of electrodes are connected to each other and at least a portion where the electrodes are connected to each other is formed into a narrow portion.

### BRIEF DESCRIPTION OF THE DRAWINGS

FIG. 1A is a cross-sectional view of an HID lamp according to a first embodiment of the present invention;

FIG. 1B is a top view of the HID lamp shown in FIG. 1A;

FIG. 1C is a cross-sectional view of the HID lamp shown in FIG. 1B;

FIG. 1D is a cross-sectional view of the HID lamp shown in FIG. 1B;

FIG. 2 is a top view of an example in which a plurality of the HID lamps according to the first embodiment is formed on a sapphire substrate;

FIG. 3 is a schematic view for explaining an operational mechanism of the HID lamp according to the first embodiment;

FIG. 4 is another schematic view for explaining the operational mechanism of the HID lamp according to the first embodiment;

FIG. 5 is a cross-sectional view of a modification of the HID lamp according to the first embodiment;

FIGS. 6A to 6D show views for explaining a producing process of the HID lamp according to the first embodiment;

FIGS. 7A to 7D show views for explaining the producing process of the HID lamp according to the first embodiment;

FIGS. 8A to 8D show views for explaining a producing process of the HID lamp according to the first embodiment;

FIGS. 9A to 9D show views for explaining a producing process of the HID lamp according to the first embodiment;

FIGS. 10A to 10D show views for explaining a producing process of the HID lamp according to the first embodiment;

FIGS. 11A to 11D show views for explaining a producing process of the HID lamp according to the first embodiment;

FIGS. 12A to 12D show views for explaining a producing process of the HID lamp according to the first embodiment;

FIGS. 13A to 13D show views for explaining a producing process of the HID lamp according to the first embodiment;

FIGS. 14A to 14D show views for explaining a producing process of the HID lamp according to the first embodiment;

FIGS. 15A to 15D show views for explaining a producing process of the HID lamp according to the first embodiment;

FIGS. 16A to 16D show views for explaining a producing process of the HID lamp according to the first embodiment;

FIG. 17A is a cross-sectional view of an HID lamp according to a second embodiment of the present invention;

FIG. 17B is a top view of the HID lamp shown in FIG. 17A;

FIG. 17C is a cross-sectional view of the HID lamp shown in FIG. 17B;

FIG. 17D is a cross-sectional view of the HID lamp shown in FIG. 17B;

FIG. 18 is a cross-sectional view for explaining a producing process of the HID lamp according to the second embodiment;

FIG. 19 is a cross-sectional view of a modification of the HID lamp according to the second embodiment;

FIG. 20A is a cross-sectional view of an HID lamp according to a third embodiment of the present invention;

FIG. 20B is a top view of the HID lamp shown in FIG. 20A;

FIG. 20C is a cross-sectional view of the HID lamp shown in FIG. 20B;

FIG. 20D is a cross-sectional view of the HID lamp shown in FIG. 20B;

FIG. 21 is a cross-sectional view for explaining a producing process of the HID lamp according to the third embodiment;

FIG. 22 is a cross-sectional view for explaining a producing process of the HID lamp according to the third embodiment;

FIG. 23 is a cross-sectional view of a modification of the HID lamp according to the third embodiment;

FIG. 24A is a cross-sectional view of an HID lamp according to a fourth embodiment of the present invention;

FIG. 24B is a top view of the HID lamp shown in FIG. 24A;

FIG. 24C is a cross-sectional view of the HID lamp shown in FIG. 20B;

FIG. 25 is a cross-sectional view of a modification of the HID lamp according to the fourth embodiment;

FIGS. 26A to 26C show views for explaining the producing process of the HID lamp according to the fourth embodiment;

FIGS. 27A to 27C show views for explaining the producing process of the HID lamp according to the fourth embodiment;

FIGS. 28A to 28C show views for explaining the producing process of the HID lamp according to the fourth embodiment;

FIGS. 29A to 29C show views for explaining the producing process of the HID lamp according to the fourth embodiment;

FIGS. 30A to 30C show views for explaining the producing process of the HID lamp according to the fourth embodiment;

FIGS. 31A to 31C show views for explaining the producing process of the HID lamp according to the fourth embodiment;

FIGS. 32A to 32C show views for explaining the producing process of the HID lamp according to the fourth embodiment;

FIGS. 33A to 33C show views for explaining the producing process of the HID lamp according to the fourth embodiment;

FIGS. 34A to 34C show views for explaining the producing process of the HID lamp according to the fourth embodiment;

FIGS. 35A to 35C show views for explaining the producing process of the HID lamp according to the fourth embodiment;

FIGS. 36A to 36C show views for explaining the producing process of the HID lamp according to the fourth embodiment;

FIGS. 37A to 37C show views for explaining the producing process of the HID lamp according to the fourth embodiment;

FIGS. 38A to 38C show views for explaining the producing process of the HID lamp according to the fourth embodiment;

FIGS. 39A to 39C show views for explaining the producing process of the HID lamp according to the fourth embodiment;

FIG. 40A is a cross-sectional view of an HID lamp according to a fifth embodiment of the present invention;

FIG. 40B is a top view of the HID lamp shown in FIG. 40A; and

FIG. 41 is a schematic side view of an HID lamp according to a sixth embodiment of the present invention.

### DETAILED DESCRIPTION OF THE INVENTION

Exemplary embodiments of the present invention will be described in detail below with reference to the accompanying drawings. The present invention is not limited to these exemplary embodiments, and various modifications can be made to the present invention without departing from the scope of the present invention. Scales used for the accompanying drawings or parts shown in the accompanying drawings can differ for convenience of descriptions.

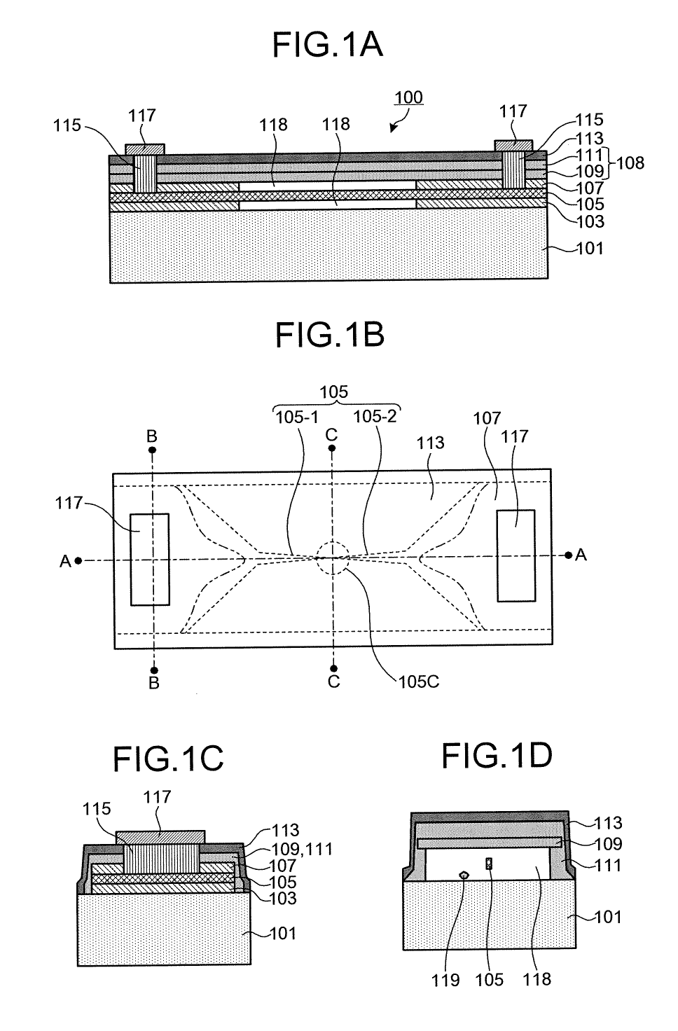

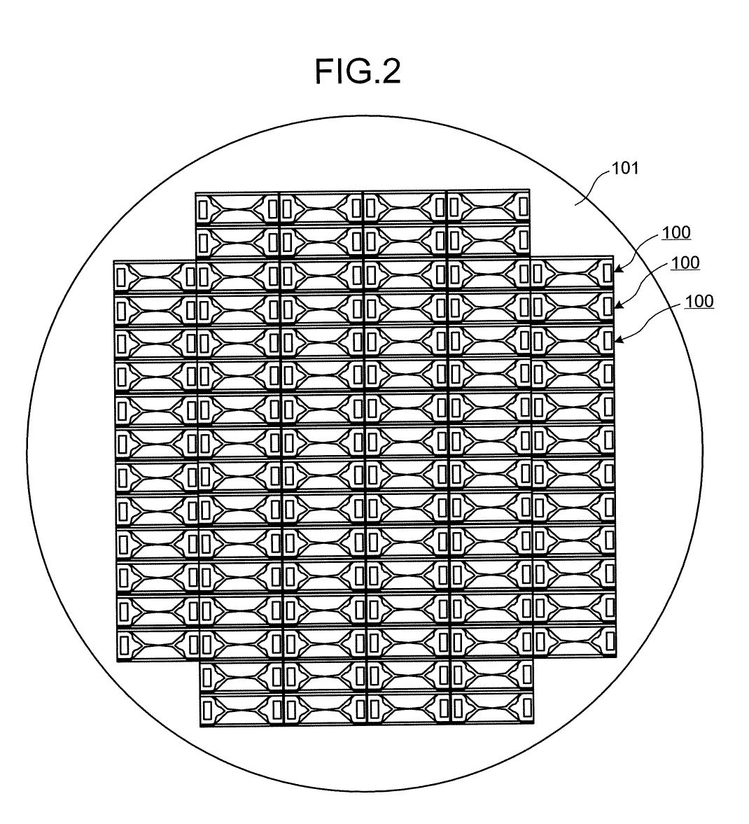

FIG. 1A is a cross-sectional view of a high voltage discharge lamp, such as an HID lamp 100 according to a first embodiment. In FIGS. 1A to 16D, FIG. nB is a top view of an HID lamp shown in FIG. nA, FIG. nC is a cross-sectional view along a B-B line in FIG. nB, and FIG. nD is a cross-sectional view along a C-C line in FIG. nB, where “n” is a natural number from 1 to 16. FIG. 2 is a top view of an example in which a plurality of the HID lamps 100 is formed on a sapphire substrate.

The HID lamp 100 includes a sapphire substrate 101, a first sidewall layer 103, an electrode layer 105, a second sidewall layer 107, a cap layer 108, a passivation layer 113, contact plugs 115, and contact electrodes 117. The sapphire substrate 101, the first sidewall layer 103, the electrode layer 105, the second sidewall layer 107, and the cap layer 108 forms a discharge chamber 118. The discharge chamber 118 encapsulates a discharge gas, an amalgam 119 as a discharge medium element, and a slight amount of hydrogen.

The sapphire substrate 101 is a supporting substrate of the HID lamp 100 and defines, together with the other members, the discharge chamber 118. Other than sapphire, any material with properties of insulation, light transparency (higher light transparency is desirable), and chemical resistance can be used for the supporting substrate. The chemical resistance, herein, means inactiveness and resistance to chemical materials encapsulated in the discharge chamber 118. The sapphire substrate or a quartz substrate is appropriate for the supporting substrate.

The first sidewall layer 103 supports the electrode layer 105 and defines, together with the other members, the discharge chamber 118. It is possible to use a material with the chemical resistance defined above for the first sidewall layer 103. More particularly, it is desirable to use a material for the first sidewall layer 103 such as polysilicon, which has a high etching selectivity against layers immediately above or below the first sidewall layer 103 (that is, the sapphire substrate 101 and the electrode layer 105).

The electrode layer 105 is made of conductive diamond, one of a diamond semiconductor as an electron emissive material, and includes a pair of electrodes 105-1 and 105-2 and a narrowed portion 105C where the electrodes 105-1 and 105-2 are connected to each other. Other than the conductive diamond, any wide-gap semiconductor can be used for forming the electrode layer 105. The wide-gap semiconductor, herein, means a semiconductor with a larger bandgap than that of silicon (Si).

The second sidewall layer 107 supports the electrode layer 105 and defines, together with the other members, the discharge chamber 118. It is possible to use a material with the chemical resistance defined above for the second sidewall layer 107. More particularly, it is desirable to use a material, such as polysilicon, which has a high etching selectivity against layers immediately above or below the first sidewall layer 103 (that is, the sapphire substrate 101 and the electrode layer 105).

The cap layer 108 defines, together with the other members, the discharge chamber 118. The cap layer 108 includes a first cap layer 109 and a second cap layer 111. The cap layer 108 is made of a material, such as insulating diamond, with the properties of insulation, light transparency, and the chemical resistance defined above.

The passivation layer 113 is formed to prevent oxidization of the cap layer 108, and is made of a silicon oxide film or the like. Other than the silicon oxide film, any material with the capability of preventing the oxidization of the cap layer 108 can be used for forming the passivation layer 113. For example, an aluminum oxide film, an aluminum nitride film, and silicon nitride film can be used instead of the silicon oxide film. Furthermore, the passivation layer 113 can include two or more layers selected from the above films.

It is possible to change a condition whether the above members are required to have a light permeability depends on a direction in which a light retrieving region is formed.

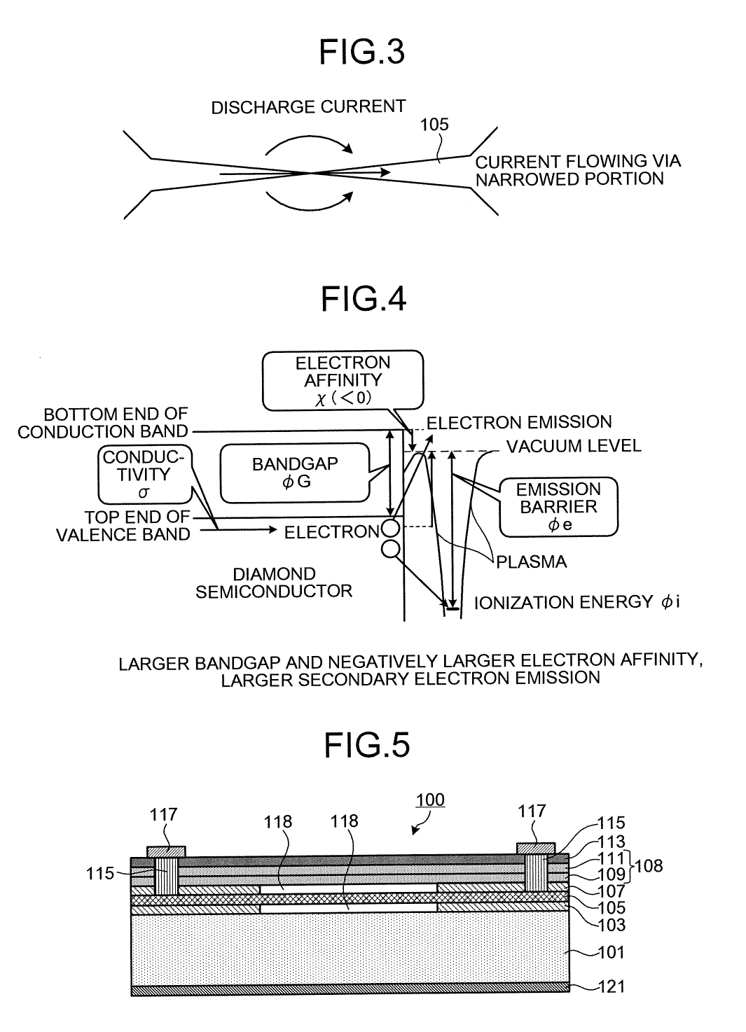

Effects of the HID lamp 100 are described bellow on each factor. Following effects are obtained from the electrode layer 105 made of the conductive diamond, or the wide-gap semiconductor, including the electrodes 105-1 and 105-2 which are connected to each other in the narrowed portion 105C. As shown in FIG. 3, a current starts flowing between the electrodes 105-1 and 105-2 via the narrowed portion 105C without discharging. For this reason, a power starts input without an extremely high voltage required in the conventional method.

As an amount of the current flowing between the electrodes 105-1 and 105-2 increases, the flowing current makes the narrowed portion 105C hot and the temperature of the HID lamp 100 increases locally. Therefore, charge energy in the semiconductor near the narrowed portion 105C increases, thereby substantially decreasing a work function. At the same time, by using the wide-gap semiconductor, low electron affinity is obtained. The obtained low electron affinity along with the thermal excitation raises density and energy of charged electrons in a conductive band.

As shown in FIG. 4, the larger bandgap ΦG the wide-gap semiconductor (such as a diamond semiconductor) has, the negatively larger the electron affinity X becomes, and the larger the secondary electron emission performance becomes. Therefore, the emission barrier Φe becomes low and the substantial work function decreases. As an amount of the current flowing via the narrowed portion 105C increase, a part of electrons is directly emitted from a surface of the semiconductor electrode to a gas phase and this makes another current flow which is superposed with the current flowing via the narrowed portion 105C. The emission current flow causes a discharge in a surrounding cavity. As a result, a discharge current starts flowing.

When the input power further increases, the external discharge current becomes larger than the interelectrode current flowing via the narrowed portion 105C. Through the entire process from the start of discharge to the steady discharge emission, the HID lamp 100 does not need the extremely high voltage required in the conventional start of discharge.

As a result, it is possible to reduce the voltage output from the power source and the burden on the HID lamps caused by the extremely high voltage, and to avoid rising of the starting voltage. Therefore, a driving circuit for driving the HID lamp 100 can be significantly simplified and low-cost. This is more effective for an HID lamp using a higher gas-pressure. When the HID lamp 100 starts operating again, because the gas-pressure in the discharge chamber 118 is high, the starting voltage does not rise further. By solving the problem of dealing with the complicated driving circumstances, that is the high-voltage and low-current state in the start of discharge and in the low-voltage and high-current in the stable operation, it is possible to realize the HID lamp 100 with the low starting-voltage and easy to operate.

Moreover, by using the diamond semiconductor as the wide-gap semiconductor, the wide-gap semiconductor can obtain a lower electron affinity, especially a negative electron affinity at the surface. A hydrogen-terminated surface caused by the slight amount of hydrogen gas helps lowering the electron affinity. In other words, the slight amount of hydrogen gas contained in the discharge chamber 118 is effective to lower the electron affinity.

As described above, by using the diamond semiconductor as the wide-gap semiconductor for the electrodes 105-1 and 105-2, electrons are preferentially emitted from the narrowed portion 105C of the electrodes 105-1 and 105-2 to the gas phase, which increase a ratio of the discharge current acting for light emitting compared to the interelectrode current flowing in the solid phase.

Furthermore, the structure of the HID lamp 100 can be formed by a planer technique including laminating steps and selective etching steps as a main part. Therefore, the HID lamp 100 can be easily and accurately produced, even using a layer made of a material hard to process, such as the diamond semiconductor. Fine structure such as a bottleneck junction can also be manufactured accurately.

Moreover, the high voltage discharge lamp according to the first embodiment constitutes an insulating inner wall with a laminated structure of thin films. This enables to widen the range of choice in materials which has been required conventionally to be satisfied both of manufacturing a discharge lamp and processing into a valve shape.

Furthermore, to obtain rich color rendering properties and a high lightening efficiency, it is required to have an active discharge medium, such as a metallic halide, react under a high gas-pressure. However, the conventional glass material does not have a corrosion resistance and a heat resistance high enough to satisfy the above requirements. In the conventional method, using glass as the material restricts the chemical resistance and the heat resistance in the light of the material characteristics and the processing technique.

On the other hand, it is possible to form the high voltage discharge lamp by combining a material for increasing the structural strength against the high pressure and a material for the inner wall that is required to have the chemical resistance and the discharge-resistance. More particularly, the diamond semiconductor used in the high voltage discharge lamp brings both the mechanical strength suitable for the cell body and the heat and chemical resistance suitable for the inner wall layer, which causes the high voltage discharge lamp an excellent durability.

Moreover, the producing process of the conventional tube-structured high voltage discharge lamps inevitably includes a step of pressing and deforming members one by one, which makes it difficult to produce the conventional high voltage discharge lamps in a large amount. Glass has ideal characteristics for a discharge container, such as the excellent thermoplasticity, the insulation, the high airtight property, and the high pressure resistance. However, glass is processed after heated and obtaining the plasticity, so that members made of glass are processed one by one by pressed and deformed.

Therefore, it is difficult to form glass members by using the planer technique, which is a well-known technique for mass production used in processes of the semiconductor devices. Therefore, the discharge lamps remain as labor-intensive commodity products, that is, low productive products.

On the other hand, the high voltage discharge lamp has the laminated layer structure of thin-film that can be formed by the planer technique including the laminating steps and the selective etching steps as a main part. Therefore, a plurality of the high voltage discharge lamps can be accumulatively formed on the single substrate as shown in FIG. 2, which makes it possible to effectively produce the high voltage discharge lamps in a large amount.

The laminated layer structure enables the outer wall to be covered by the passivation layer 113 having resistance to outside circumstances and suitable for the light-emitting characteristics. More particularly, it is possible to form a layer for obtaining oxidation resistance in a high temperature when the electrodes are made of the diamond semiconductor. Moreover, by using diamond not only for the electrodes but also for the wall layer, heat is conducted evenly, which prevents undesirable segregation of the discharge medium due to temperature unevenness.

As shown in FIG. 5, a reflecting layer 121 can be additionally formed on a surface of the sapphire substrate 101 opposite to the other surface of the sapphire substrate 101 on which the first sidewall layer 103 is formed. The reflecting layer 121 enables the HID lamp 100 to lighten in a selected single direction, which makes it possible to improve the lightening efficiency. Thus, the HID lamp 100 can lighten in the more effective manner. It is allowable to form the reflecting layer 121 on the passivation layer 113 to emit the light from the surface of the sapphire substrate 101.

A method of producing the high voltage discharge lamp is described below in detail. A thin-film laminating layer technique and an etching technique are used in the method.

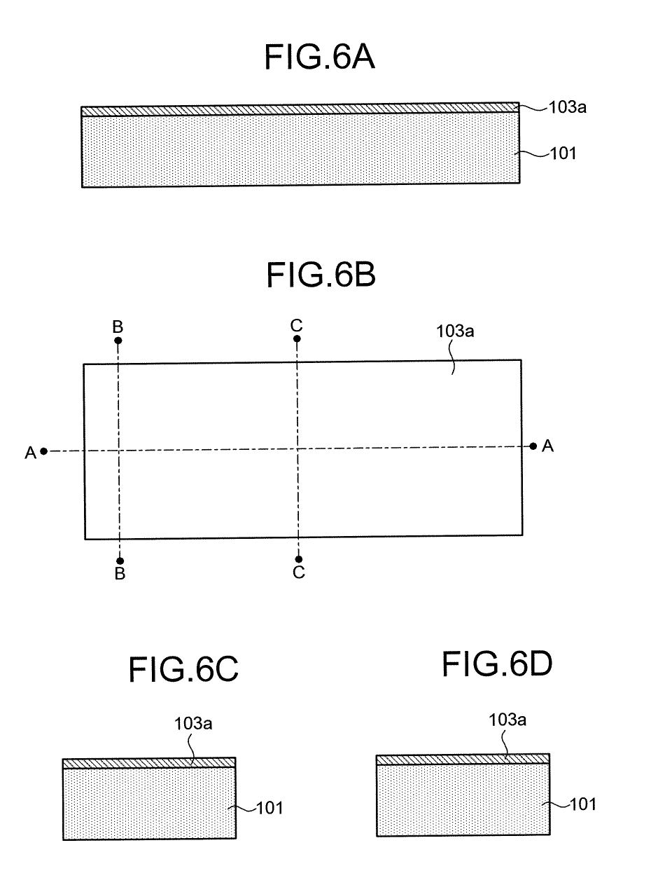

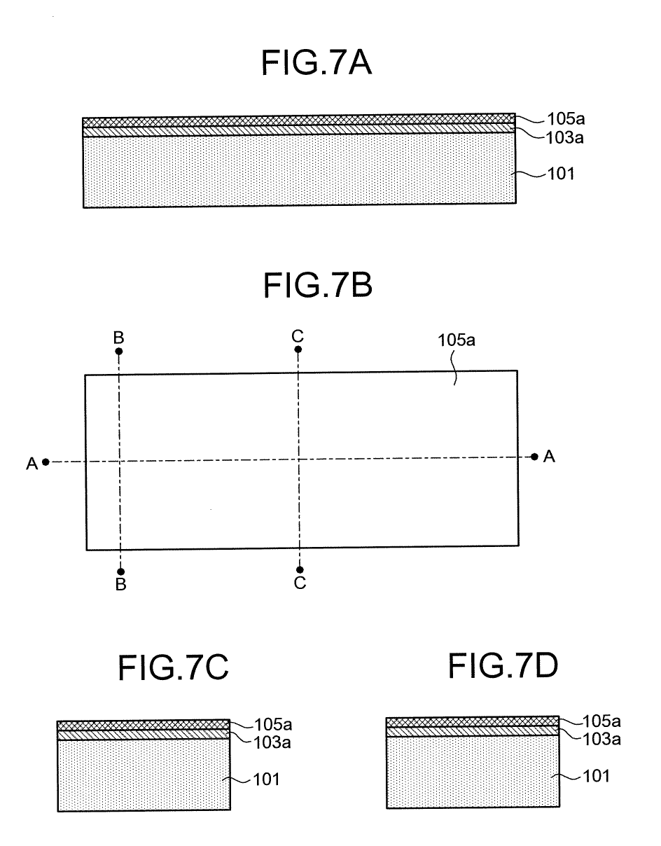

The sapphire substrate 101 is prepared as a substrate. FIGS. 6A, 6C and 6D are cross-sectional views and FIG. 6B is a top view. As shown in FIGS. 6A to 6D, a polysilicon layer 103a acting as a sacrificial layer is formed on the sapphire substrate 101 as the first sidewall layer 103 by the chemical vapor deposition (CVD) method. FIGS. 7A, 7C and 7D are cross-sectional views and FIG. 7B is a top view. As shown in FIGS. 7A to 7D, a conductive diamond layer 105a to be formed into the discharge electrodes is formed on the polysilicon layer 103a by the CVD method.

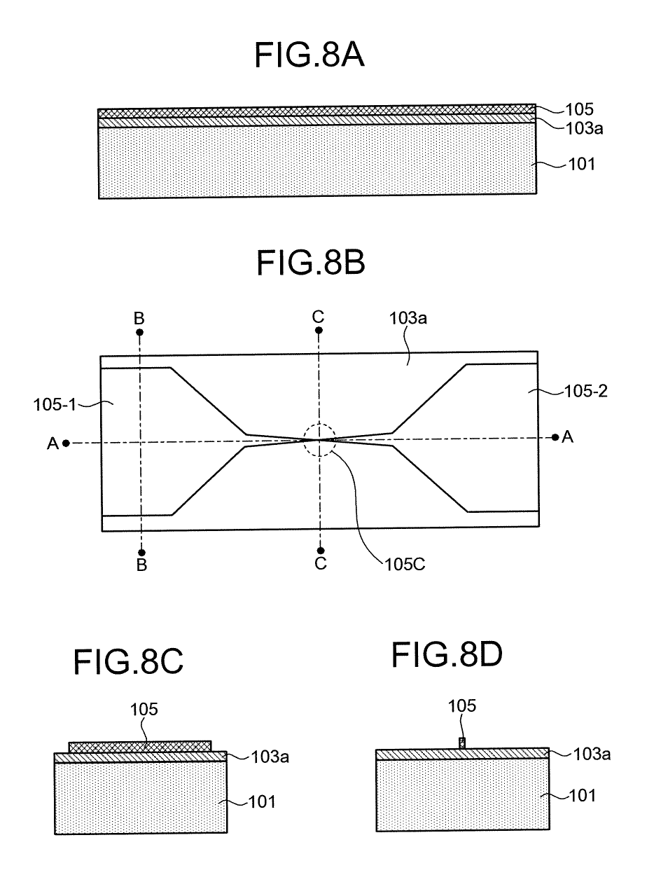

FIGS. 8A, 8C and 8D are cross-sectional views and FIG. 8B is a top view. As shown in FIGS. 8A to 8D, an electrode structure having a pair of the electrodes 105-1 and 105-2 and the narrowed portion 105C where the electrodes 105-1 and 105-2 are connected to each other via the narrowed portion 105C is formed by patterning the conductive diamond layer 105a.

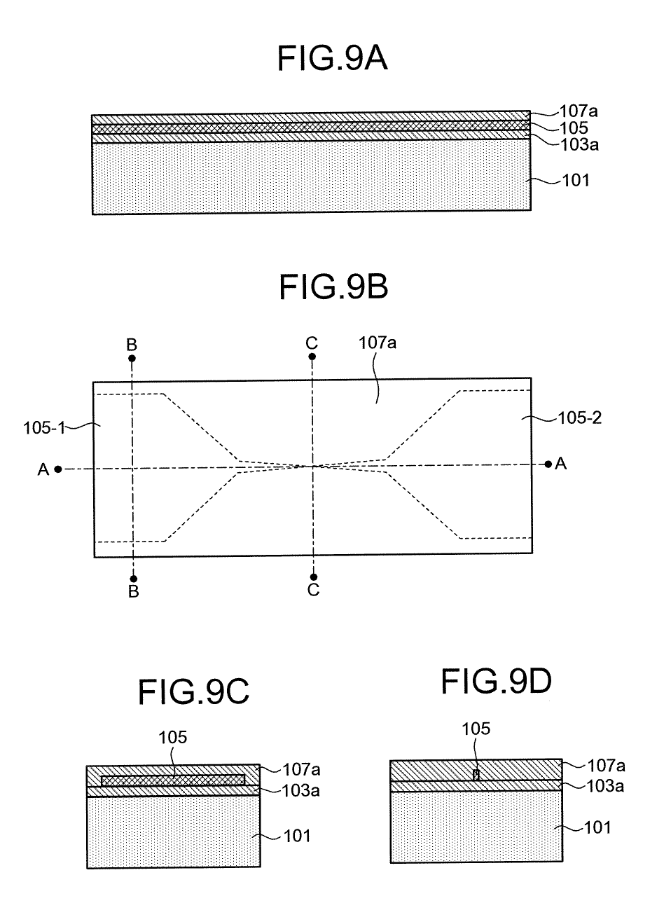

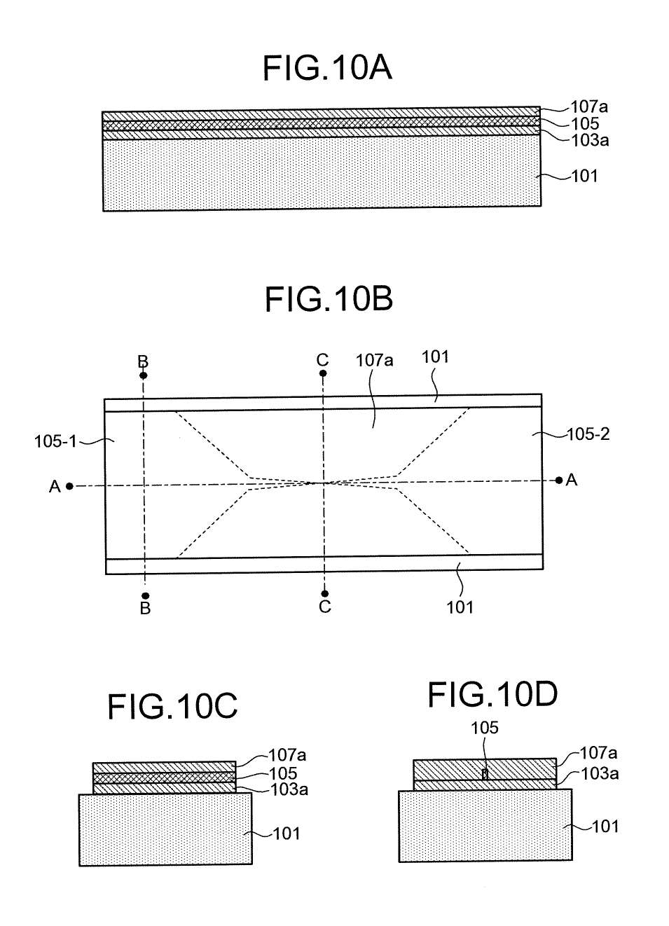

FIGS. 9A, 9C and 9D are cross-sectional views and FIG. 9B is a top view. As shown in FIGS. 9A to 9D, a polysilicon layer 107a acting as a sacrificial layer is formed on the whole surface of the sapphire substrate 101 as the second sidewall layer 107. FIGS. 10A, 10C and 10D are cross-sectional views and FIG. 10B is a top view. As shown in FIGS. 10A to 10D, parts of the polysilicon layers 103a and 107a positioned at a marginal area of the HID lamp 100 on the sapphire substrate 101 are removed by a selective etching process.

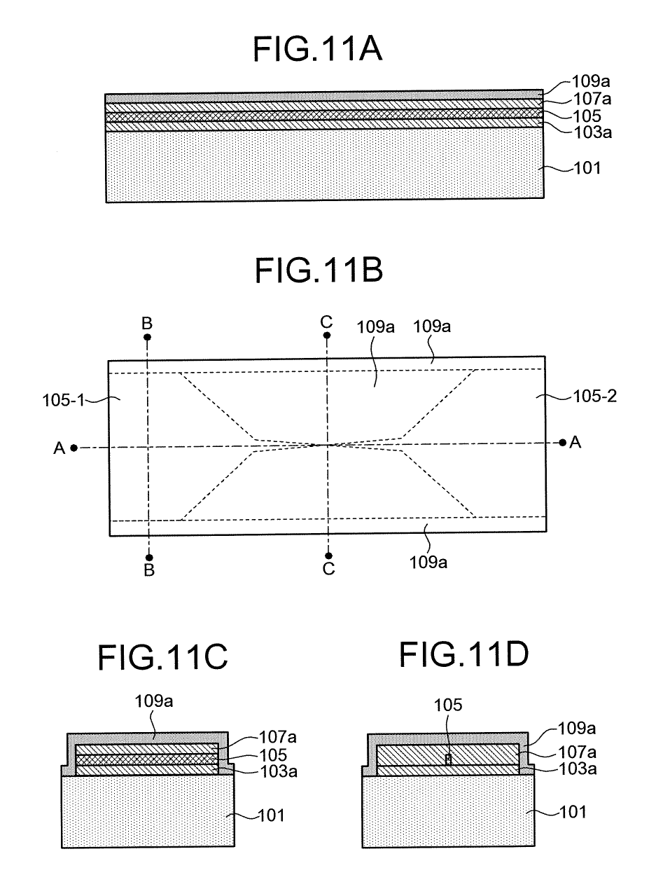

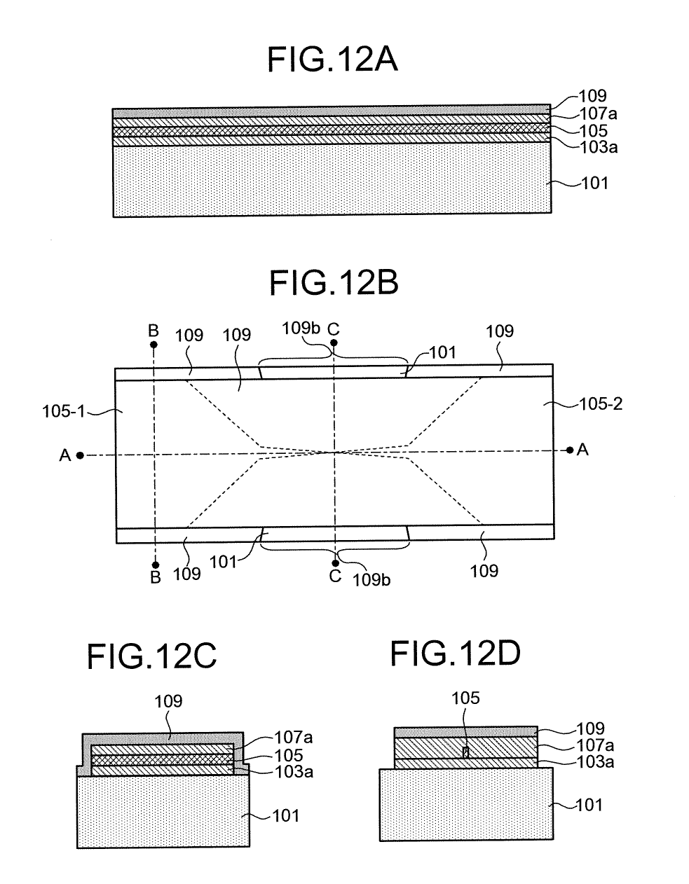

FIGS. 11A, 11C and 11D are cross-sectional views and FIG. 11B is a top view. As shown in FIGS. 11A to 11D, an insulating diamond layer 109a that defines an inner wall of the discharge chamber 118 is formed on the polysilicon layer 107a as the cap layer 108 by the CVD method. FIGS. 12A, 12C and 12D are cross-sectional views and FIG. 12B is a top view. As shown in FIGS. 12A to 12D, etching holes 109b are formed by selectively removing parts of the insulating diamond layer 109a positioned parts of the marginal area for each of the high voltage discharge lamp by an etching process. The etching holes 109b are used for removing the sacrificial layers, i.e., the polysilicon layers 103a and 107a, in an etching process. The first cap layer 109 is thus formed.

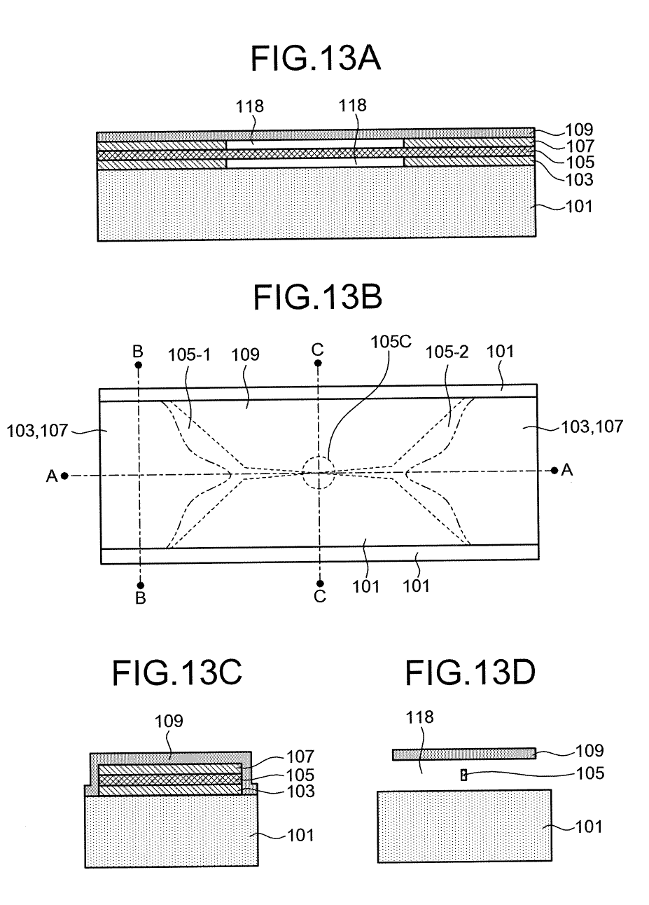

FIGS. 13A, 13C and 13D are cross-sectional views and FIG. 13B is a top view. As shown in FIGS. 13A to 13D, the polysilicon layers 103a and 107a positioned around the narrowed portion 105C are removed by an etching solution supplied from the etching holes 109b. A cavity formed by the etching process is the discharge chamber 118.

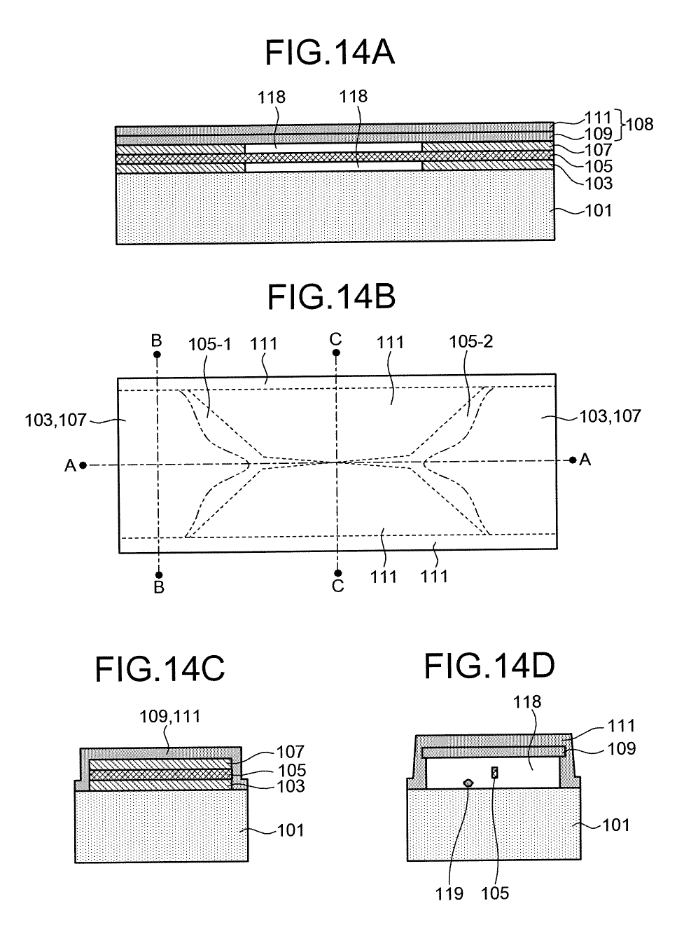

FIGS. 14A, 14C and 14D are cross-sectional views and FIG. 14B is a top view. As shown in FIGS. 14A to 14D, a discharge medium element, such as the amalgam 119, is supplied inside the discharge chamber 118. An insulating diamond layer is laminated and formed on the whole surface of the sapphire substrate 101 as the second cap layer 111 to seal the discharge chamber 118 by blocking openings of the discharge chamber 118.

A lamination of the insulating diamond layer is performed by using the CVD method. A film formation is performed at least right before the sealing in the presence of a discharge gas (noble gas) required at the beginning of the discharge in the discharge chamber 118. Thus, the discharge chamber 118 encapsulates the desired discharge gas. In addition to the desired discharge gas, a slight amount of hydrogen gas can be present at the sealing, so that the discharge chamber 118 encapsulates a slight amount of the hydrogen gas additionally.

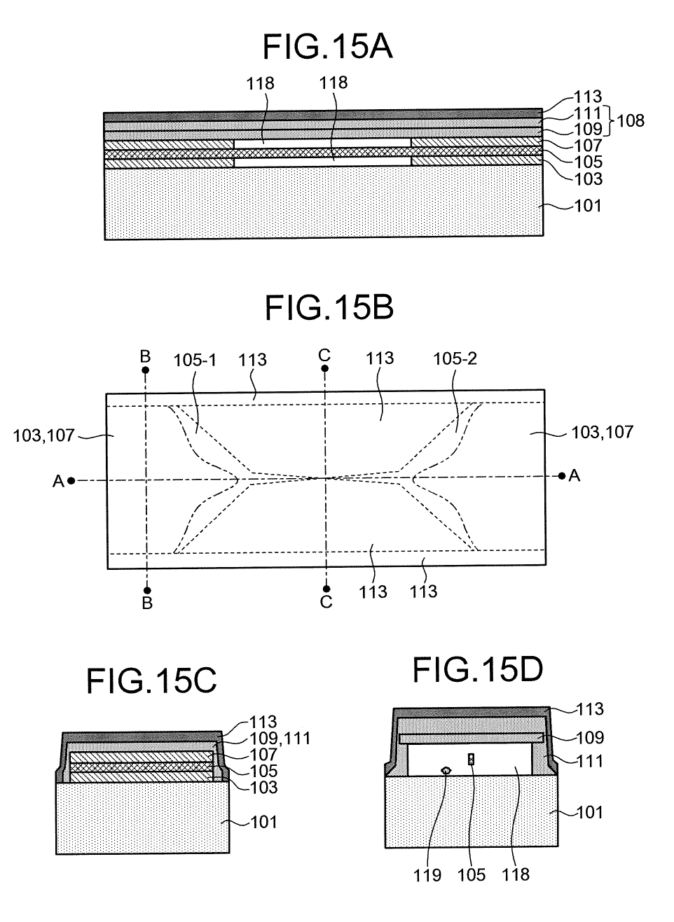

FIGS. 15A, 15C and 15D are cross-sectional views and FIG. 15B is a top view. As shown in FIGS. 15A to 15D, a layer such as a silicon dioxide (SiO2) film is laminated and formed on the second cap layer 111 as the passivation layer 113. If necessarily, the second cap layer 111 is adjusted in the thickness or the shape, before the passivation layer 113 is formed. This process causes the formed passivation layer 113 to have an excellent sealing performance. The SiO2 film preferably laminates on the whole surface of the second cap layer 111 by the CVD method or the like that can forms the layer uniformly even if there are some steps on the surface.

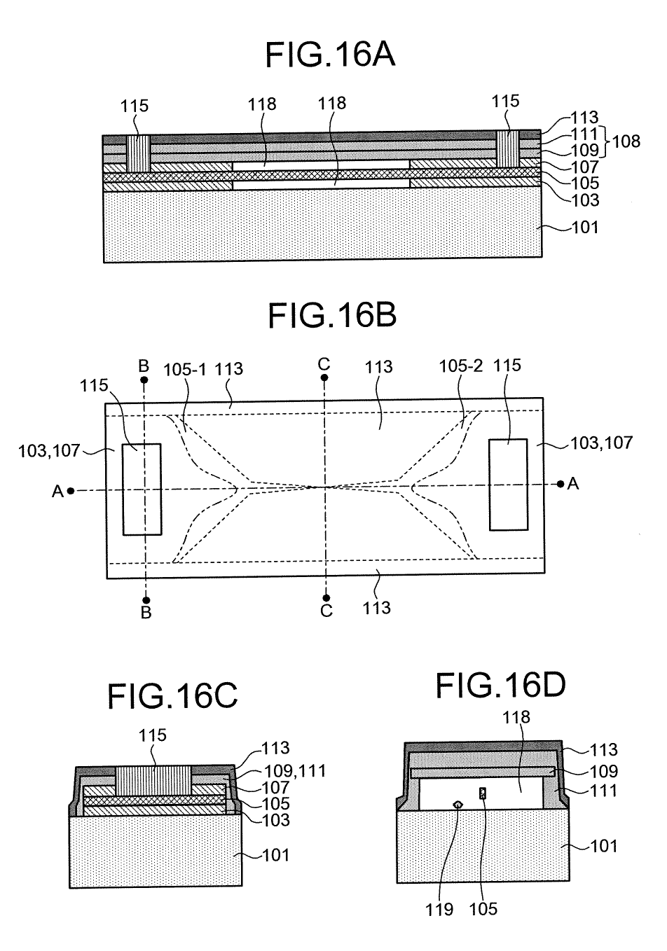

Via holes for forming electrodes connecting to the electrode layer 105 are formed, which penetrates from the passivation layer 113 to the electrode layer 105. FIGS. 16A, 16C and 16D are cross-sectional views and FIG. 16B is a top view. As shown in FIGS. 16A to 16D, the contact plugs 115 are formed by plugging a conductive material in the via holes. The contact electrodes 117 contacting to the contact plugs 115 are formed. As a result of the above processes, a plurality of the HID lamps 100 shown in FIGS. 1A to 2 is produced at one time.

As described above, the above method is effective in accurately producing the high voltage discharge lamps in a large amount by employing the thin-film lamination layer technique and the patterning technique including the etching process. If another technique like an array technique is included in the method, the produced high voltage discharge lamp can be obtained an additional value.

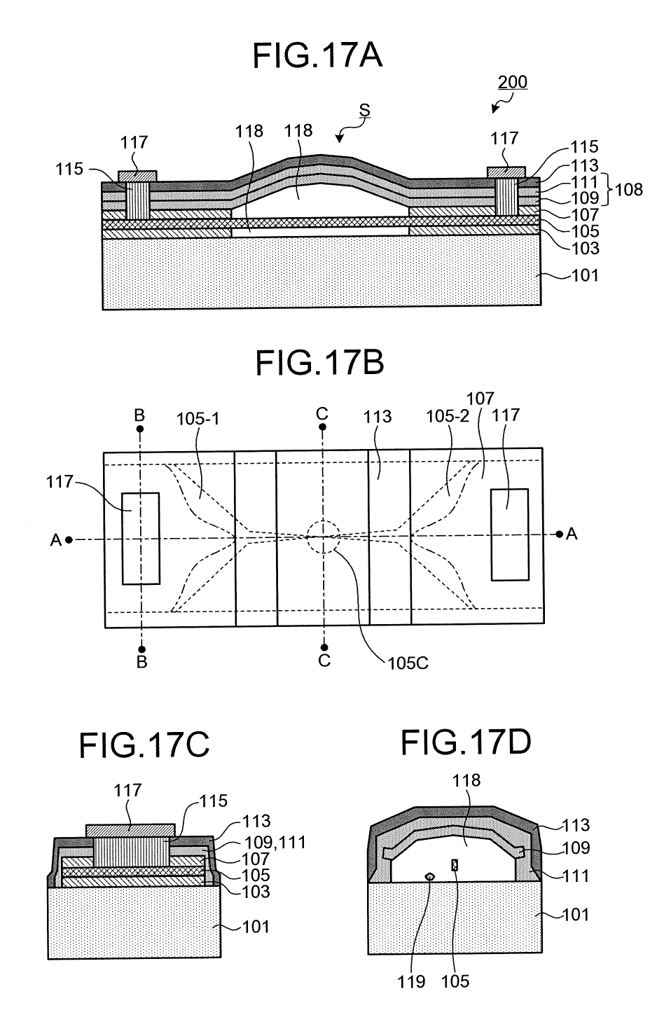

FIGS. 17A to 17D are views of a high voltage discharge lamp according to a second embodiment. FIG. 17A is a cross-sectional view and FIG. 17B is a top view of the HID lamp 200. FIG. 17C is a cross-sectional view along a B-B line in FIG. 17B, and FIG. 17D is a cross-sectional view along a C-C line in FIG. 17B. Members corresponding to those in the first embodiment are denoted with the same reference numerals, and the same description is not repeated.

An HID lamp 200 according to the second embodiment is a modification of the HID lamp 100 according to the first embodiment. In the HID lamp 200, a light retrieving surface S is formed like a convex lens, more particularly, the cap layer 108 and the passivation layer 113 both of which define the light retrieving surface S are formed like the convex lens.

The HID lamp 200, like the HID lamp 100, is easy to operate and has an excellent durability. Moreover, the light retrieving surface S enables the HID lamp 200 to adjust an irradiation angle and a light orientational characteristics. Therefore, the HID lamp 200 can retrieve light in the more effective manner.

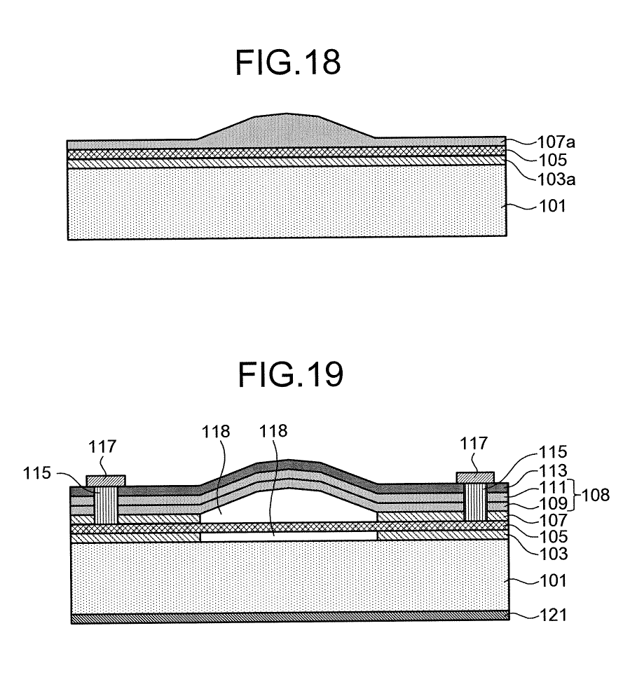

A process for producing the HID lamp 200 is similar to the process for producing the HID lamp 100 except that the polysilicon layer 107a is formed convexly as shown in FIG. 18.

As shown in FIG. 19, the reflecting layer 121 can be additionally formed on a surface of the sapphire substrate 101 opposite to the other surface of the sapphire substrate 101 on which the first sidewall layer 103 is formed. The reflecting layer 121 enables the HID lamp 200 to retrieve light in a selected single direction, which makes it possible to improve the light retrieving characteristics of the HID lamp 200. Thus, the HID lamp 200 can retrieve light in the more effective manner.

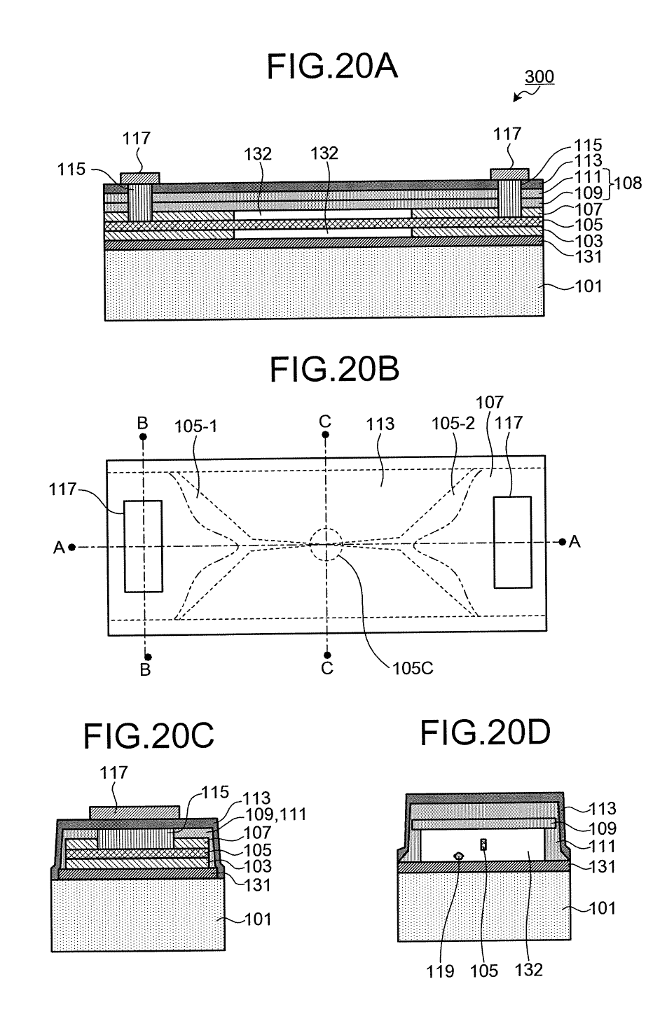

FIGS. 20A to 20D are schematic views of an HID lamp 300 according to a third embodiment. FIG. 20A is a cross-sectional view and FIG. 20B is a top view of the HID lamp 300. FIG. 20C is a cross-sectional view along a B-B line in FIG. 20B, and FIG. 20D is a cross-sectional view along a C-C line in FIG. 20B. Members corresponding to those in the first embodiment are denoted with the same reference numerals, and the same description is not repeated.

The HID lamp 300 is another modification of the HID lamp 100. In the HID lamp 300, an insulating diamond layer 131 that is the same as the first cap layer 109 is provided between the sapphire substrate 101 and the first sidewall layer 103.

The HID lamp 300, like the HID lamp 100, is easy to operate and has an excellent durability. Moreover, options of chemical materials encapsulated in a discharge chamber 132 can be widen, more particularly, a material for which sapphire is not applicable but diamond is applicable can be included into the options, because diamond is used for an inner wall of the discharge chamber 132, while sapphire is used for the inner wall of the discharge chamber 118.

In the high voltage discharge lamp according to the third embodiment, the surface of the inner wall of the discharge chamber 118 is made of diamond, while in the high voltage discharge lamp according to the first embodiment, the surface of the inner wall of the discharge chamber 118 is made of sapphire. Namely, the first cap layer 109 and the insulating diamond layer 131 both of which facing to each other across the discharge chamber 132 are made of the same material, that is, diamond. Therefore, thermal conductivity difference due to difference in constituent material of the discharge chamber 132 disappears. Further, it is possible to inhibit distortion and unevenness in the thermal distribution at the discharge chamber 132 caused by the difference in the thermal conductivity.

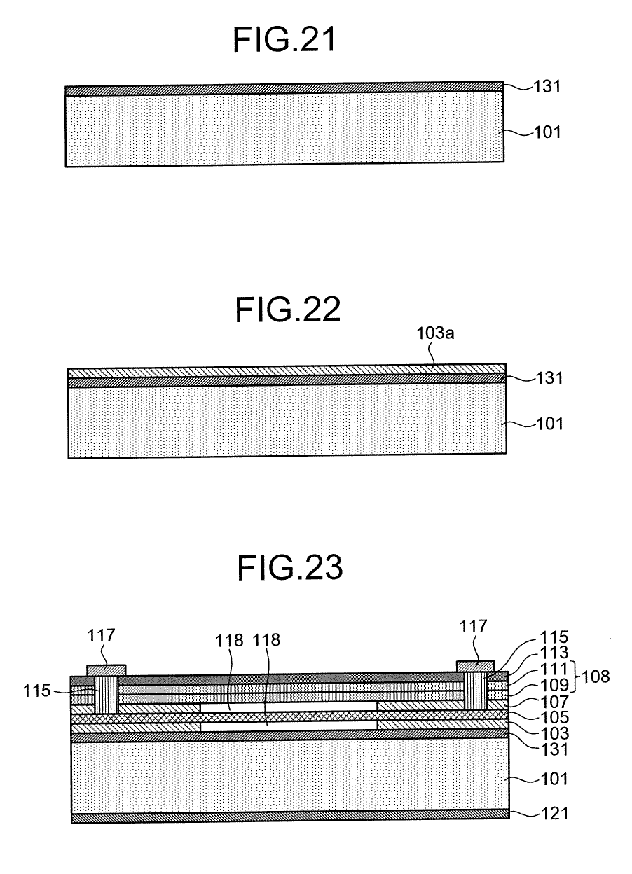

A process for producing the HID lamp 300 is similar to the process for producing the HID lamp 100 except that the insulating diamond layer 131 is formed on the sapphire substrate 101 by the CVD method as shown in FIG. 21, and subsequently the polysilicon layer 103a is formed on the insulating diamond layer 131 by the CVD method as shown in FIG. 22.

As shown in FIG. 23, the reflecting layer 121 can be additionally formed on a surface of the sapphire substrate 101 opposite to the other surface of the sapphire substrate 101 on which the first sidewall layer 103 is formed. The reflecting layer 121 enables the HID lamp 300 to retrieve light in a selected single direction, which makes it possible to improve the light retrieving characteristics of the HID lamp 300. Thus, the HID lamp 300 can retrieve light in the more effective manner.

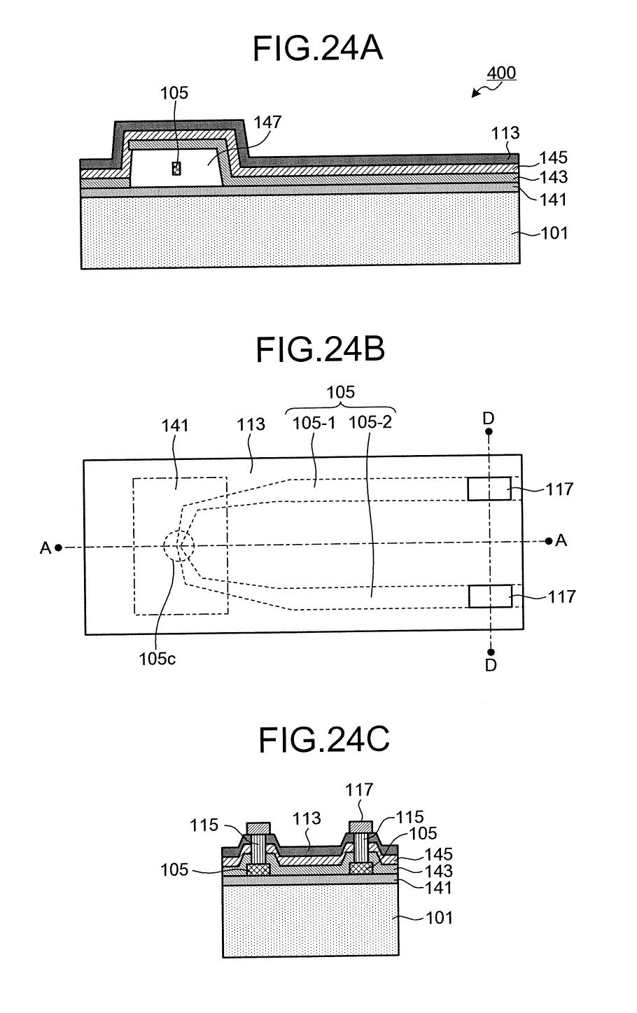

FIGS. 24A to 24C are schematic views of an HID lamp 400 according to a fourth embodiment. FIG. 24B is a top view of the HID lamp 400 shown in FIG. 24A. FIG. 24C is a cross-sectional view along a D-D line in FIG. 24B. FIG. 24A is a cross-sectional view along an A-A line in FIG. 24B.

The HID lamp 400 is still another modification of the HID lamp 100. Electrodes of the HID lamp 400 are bended to be formed into an approximately U-shape. The HID lamp 400 includes the sapphire substrate 101, a first insulating diamond layer (insulating layer) 141, a second insulating diamond layer (first cap layer) 143, a third insulating diamond layer (second cap layer) 145, the electrode layer 105, the passivation layer 113, the contact plugs 115, and the contact electrodes 117. A discharge chamber 147 is defined by the first insulating diamond layer 141, the second insulating diamond layer 143, and the third insulating diamond layer 145.

The discharge chamber 147 encapsulates a discharge gas, the amalgam 119 as a discharge medium element, and a slight amount of hydrogen. In the fourth embodiment, members corresponding to those in the first embodiment are denoted with the same reference numerals, and the same description is not repeated.

The HID lamp 400, like the HID lamp 100, is easy to operate and has an excellent durability. Moreover, because the electrodes 105-1 and 105-2 are bended to be formed into an approximately U-shape, the power supplying unit that supplies power to the electrodes 105-1 and 105-2 (i.e., the contact plugs 115 and the contact electrodes 117) can be arranged at one side in a length direction of the HID lamp 400, and various shapes can be designed for the opposite side area of the electrodes 105-1 and 105-2 where the light emission occurs, which allows the HID lamp 400 to have a wider range of orientation.

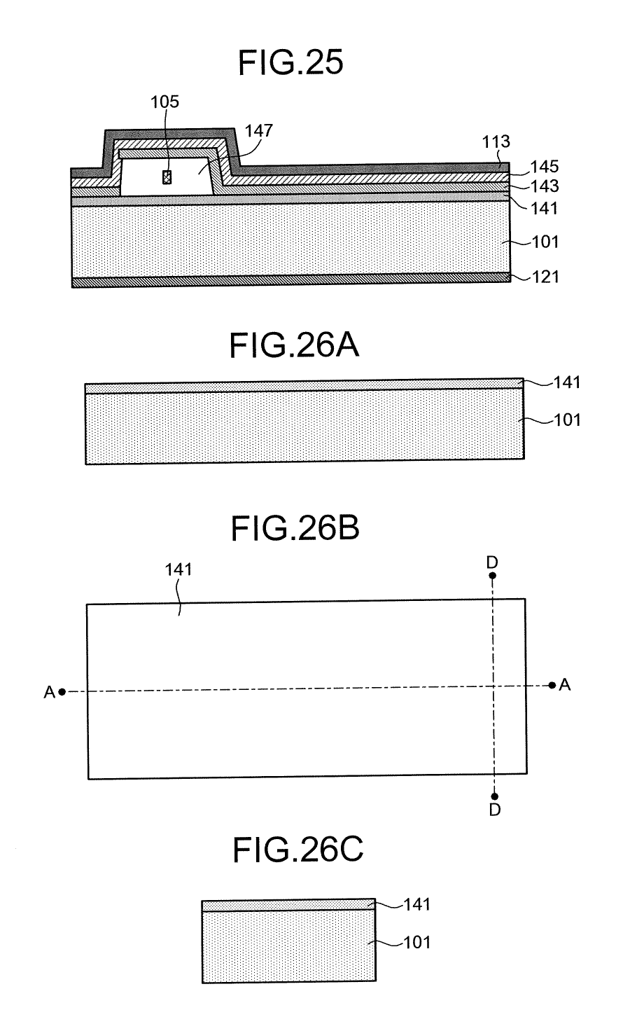

As shown in FIG. 25, the reflecting layer 121 can be additionally formed on a surface of the sapphire substrate 101 opposite to the other surface of the sapphire substrate 101 on which the first insulating diamond layer 141 is formed. The reflecting layer 121 enables the HID lamp 400 to retrieve light in a selected single direction, which makes it possible to improve the light retrieving characteristics of the HID lamp 400. Thus, the HID lamp 400 can retrieve light in the more effective manner.

A method of producing the HID lamp 400 is described in details below.

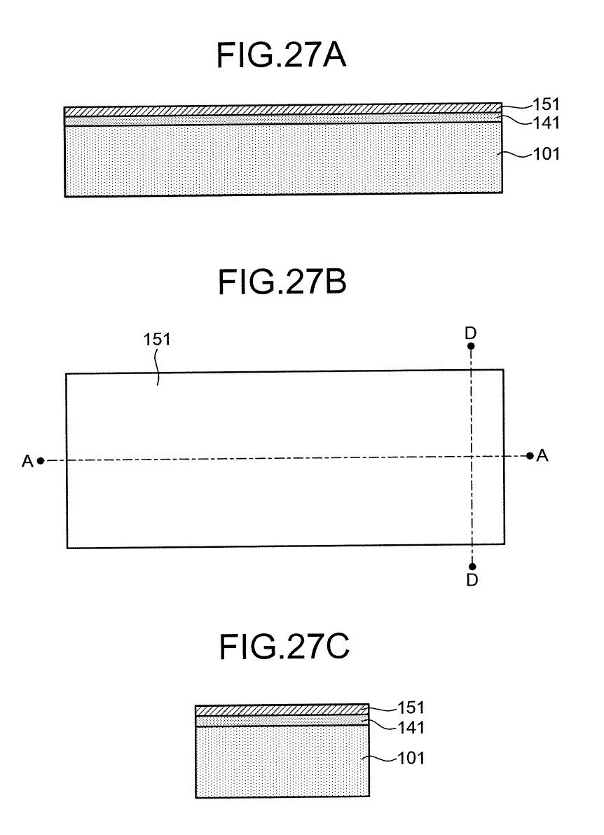

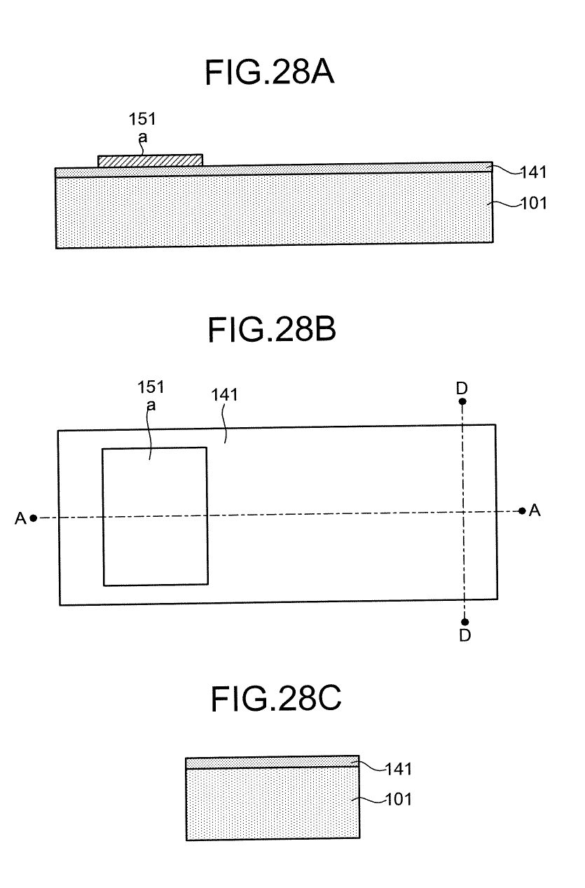

The sapphire substrate 101 is prepared as a substrate. FIGS. 26A and 26C are cross-sectional views and FIG. 26B is a top view. As shown in FIGS. 26A to 26C, the first insulating diamond layer 141 is formed on the sapphire substrate 101 by the CVD method. FIGS. 27A and 27C are cross-sectional views and FIG. 27B is a top view. As shown in FIGS. 27A to 27C, a polysilicon layer 151 acting as a sacrificial layer is then formed on the whole surface of the first insulating diamond layer 141. FIGS. 28A and 28C are cross-sectional views and FIG. 28B is a top view. As shown in FIGS. 28A to 28C, a polysilicon layer 151a is made by patterning the polysilicon layer 151 with the shape of the discharge chamber 147.

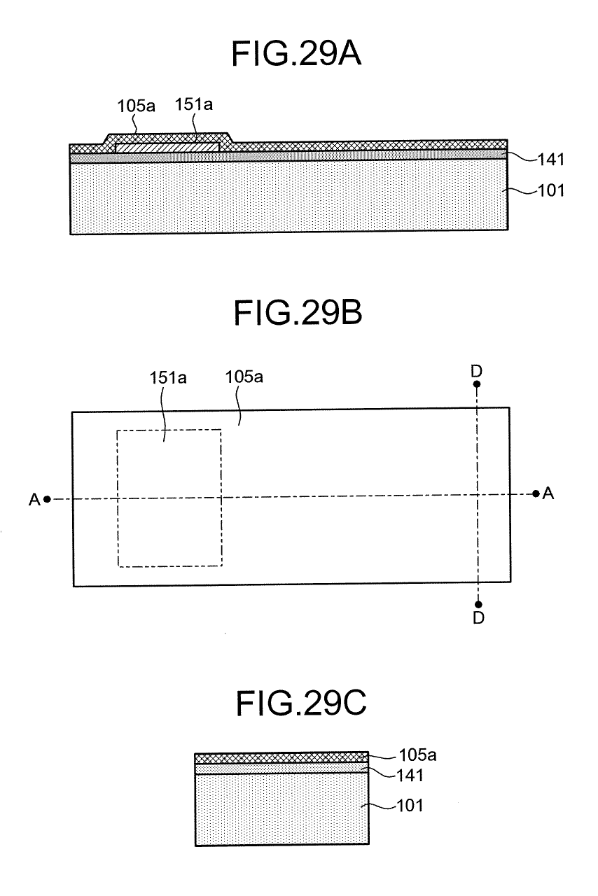

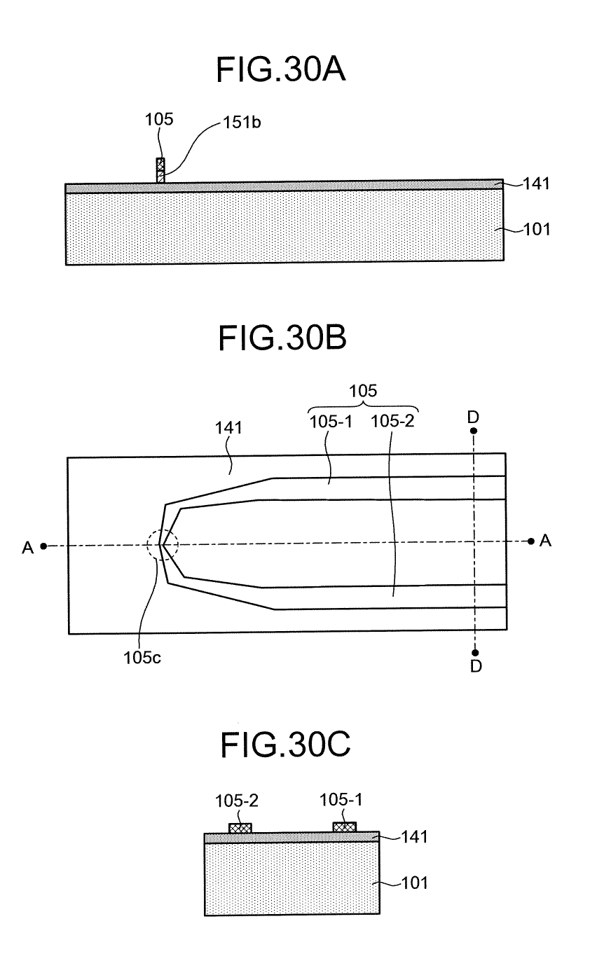

FIGS. 29A and 29C are cross-sectional views and FIG. 29B is a top view. As shown in FIGS. 29A to 29C, the conductive diamond layer 105a is formed on the whole surface of the sapphire substrate 101 by the CVD method. FIGS. 30A and 30C are cross-sectional views and FIG. 30B is a top view. As shown in FIGS. 30A to 30C, the substantial U-shaped electrode structure having the narrowed portion 105C positioned at the base of the U-shape is formed by patterning the conductive diamond layer 105a. In other words, the electrode layer 105 having the electrodes 105-1 and 105-2 connected to each other via the narrowed portion 105C is formed. A polysilicon layer 151b is made under a part of the electrode layer 105 near the narrowed portion 105C.

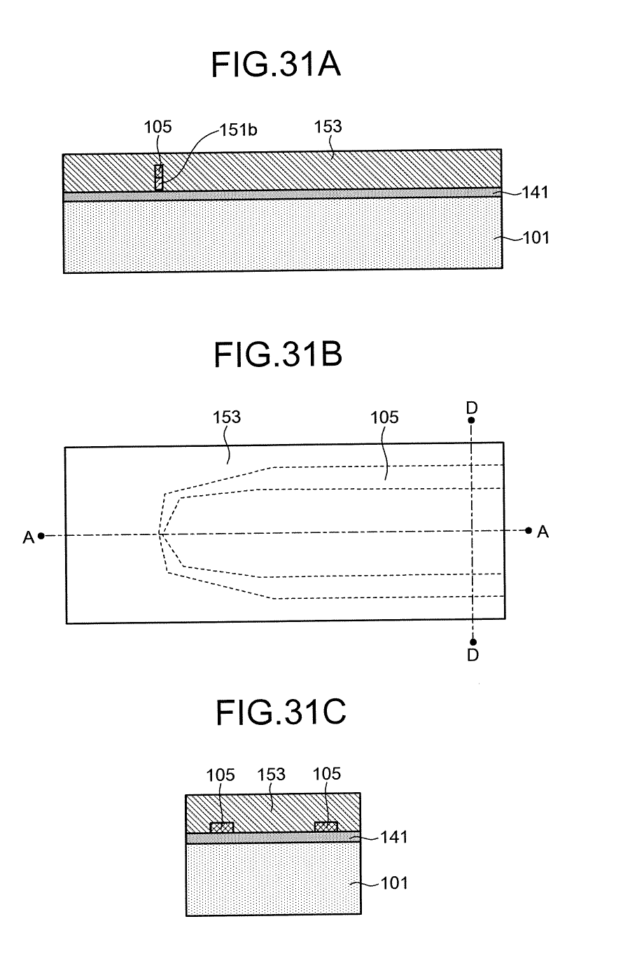

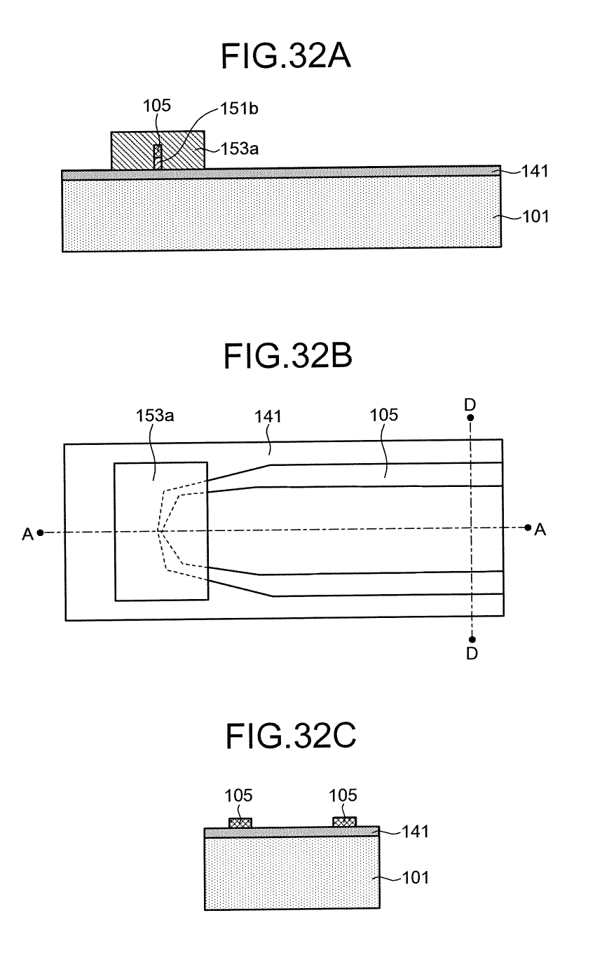

FIGS. 31A and 31C are cross-sectional views and FIG. 31B is a top view. As shown in FIGS. 31A to 31C, a polysilicon layer 153 acting as a sacrificial layer is formed on the whole surface of the sapphire substrate 101 on which the electrode layer 105 is formed. FIGS. 32A and 32C are cross-sectional views and FIG. 32B is a top view. As shown in FIGS. 32A to 32C, a polysilicon layer 153a is made by patterning the polysilicon layer 153 with the shape of the discharge chamber 147.

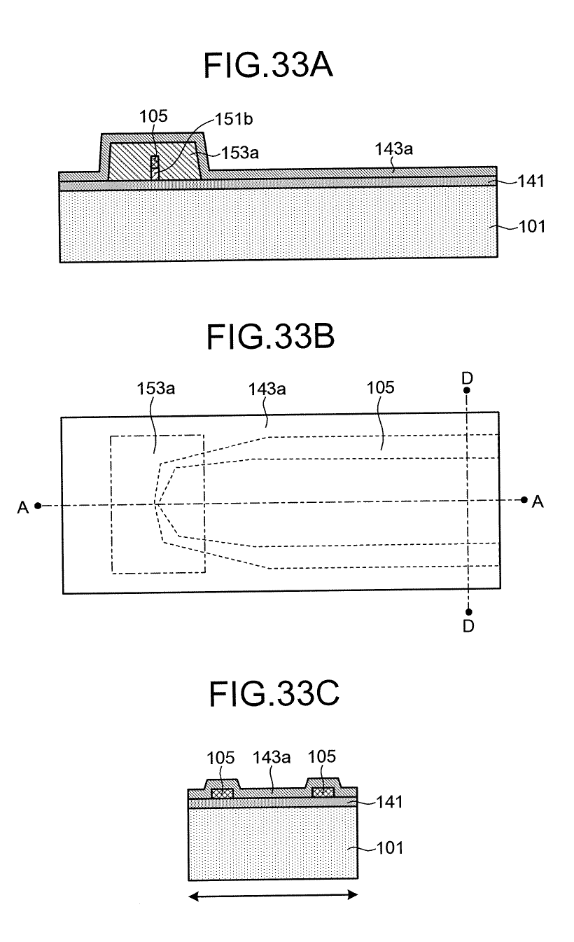

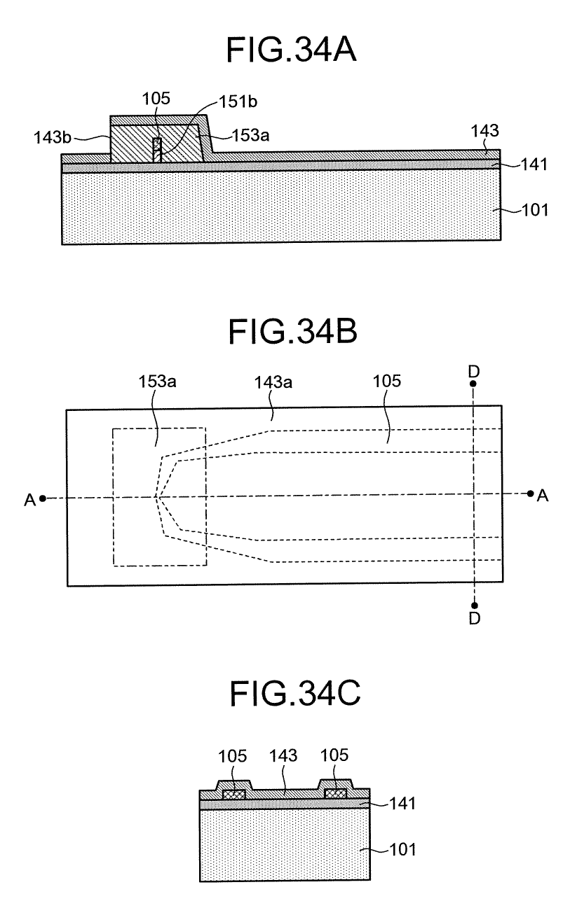

FIGS. 33A and 33C are cross-sectional views and FIG. 33B is a top view. As shown in FIGS. 33A to 33C, an insulating diamond layer 143a is formed on the whole surface of the sapphire substrate 101 as the second insulating diamond layer 143 by the CVD method. FIGS. 34A and 34C are cross-sectional views and FIG. 34B is a top view. Thereafter, as shown in FIGS. 34A to 34C, a part of the insulating diamond layer 143a is removed by an etching process to make an etching hole 143b from which a part of the polysilicon layer 153a is exposed. The second insulating diamond layer 143 is thus formed.

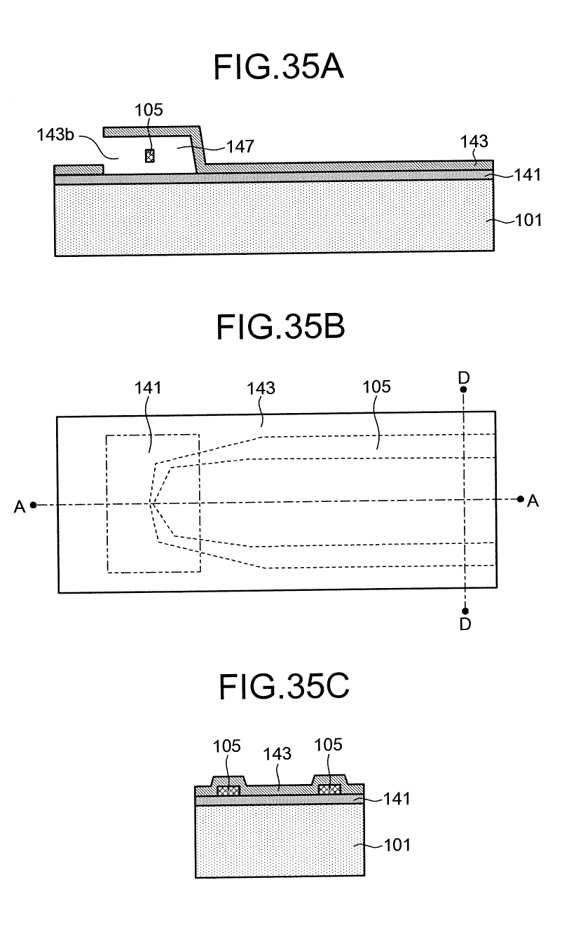

FIGS. 35A and 35C are cross-sectional views and FIG. 35B is a top view. As shown in FIGS. 35A to 35C, the polysilicon layers 153a and 151b are removed by an etching solution supplied from the etching hole 143b. A cavity formed by the etching process is the discharge chamber 147.

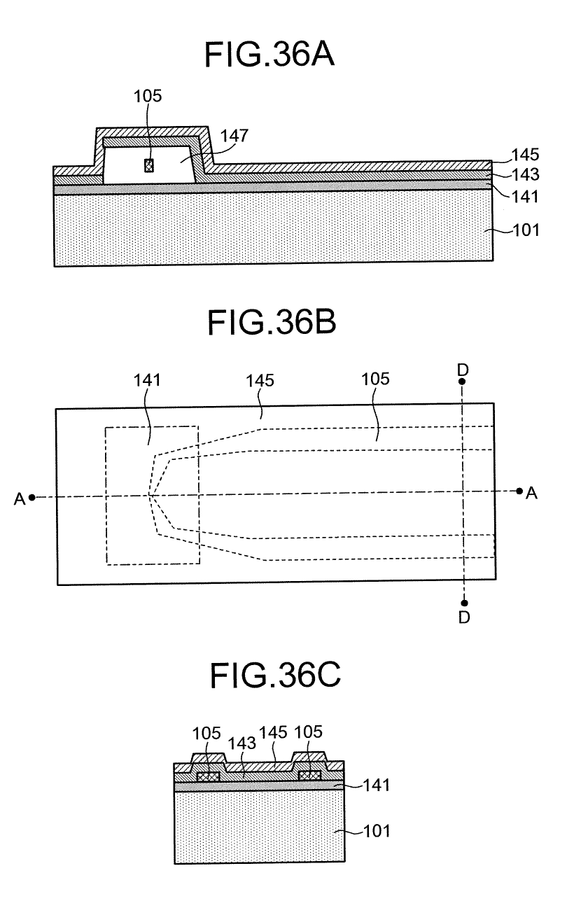

FIGS. 36A and 36C are cross-sectional views and FIG. 36B is a top view. As shown in FIGS. 36A to 36C, a discharge medium element, such as amalgam (not shown), is supplied inside the discharge chamber 147. The third insulating diamond layer 145 is laminated and formed on the whole surface of the sapphire substrate 101 to seal the discharge chamber 147 by blocking the etching hole 143b.

The third insulating diamond layer 145 is laminated by the CVD method and, at least right before the sealing, in the presence of a discharge gas (noble gas) desired at the beginning of the discharge generated in the discharge chamber 118. Thus, the discharge chamber 147 encapsulates the desired discharge gas. In addition to the desired discharge gas, a slight amount of hydrogen gas can be present at the sealing, so that the discharge chamber 147 contains a slight amount of the hydrogen gas additionally.

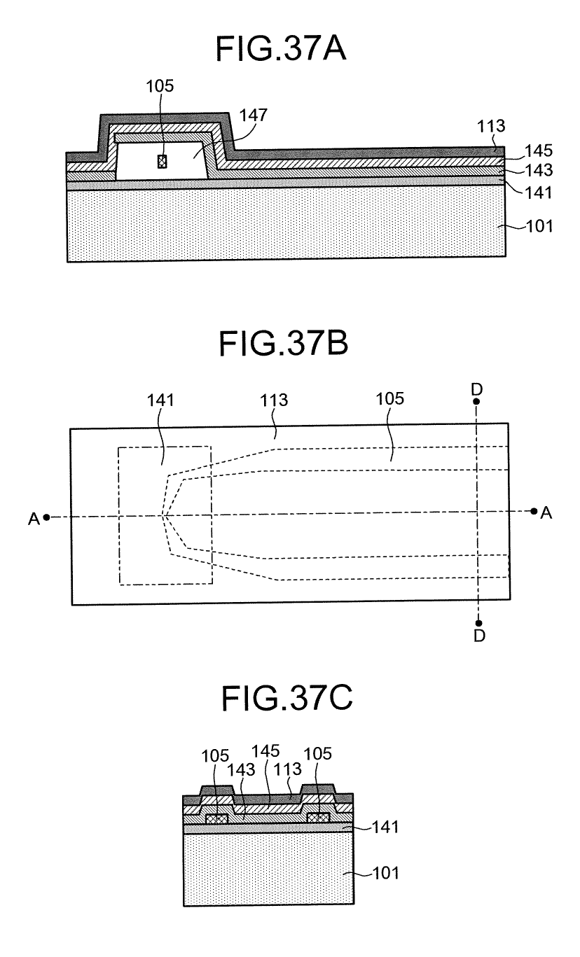

FIGS. 37A and 37C are cross-sectional views and FIG. 37B is a top view. As shown in FIGS. 37A to 37C, a SiO2 film is laminated and formed on the third insulating diamond layer 145 as the passivation layer 113. The SiO2 film is preferably laminated on the whole surface of the third insulating diamond layer 145 by the CVD method or the like that can forms the layer uniformly even if there are some steps on the surface.

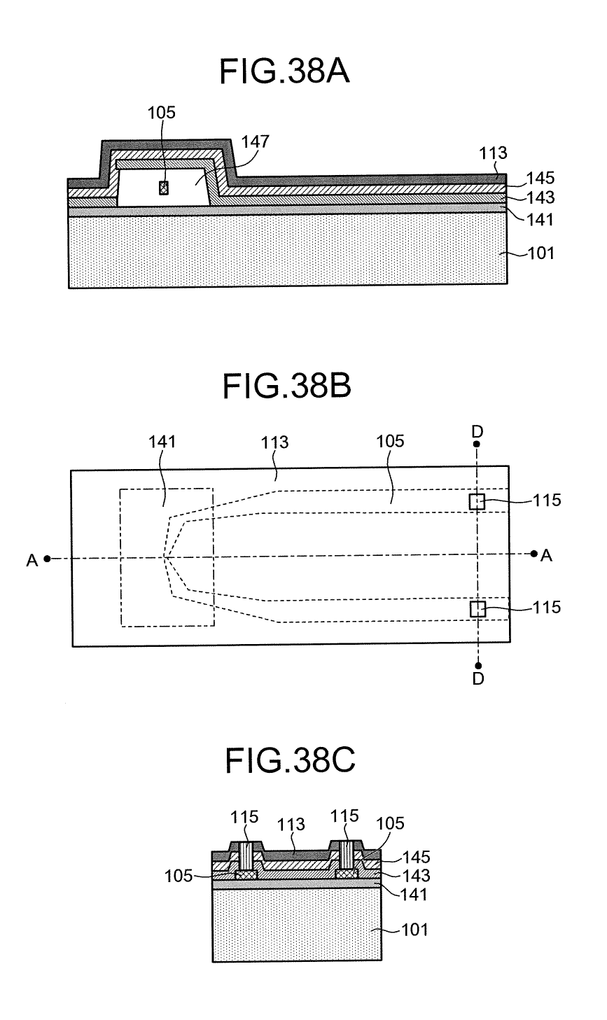

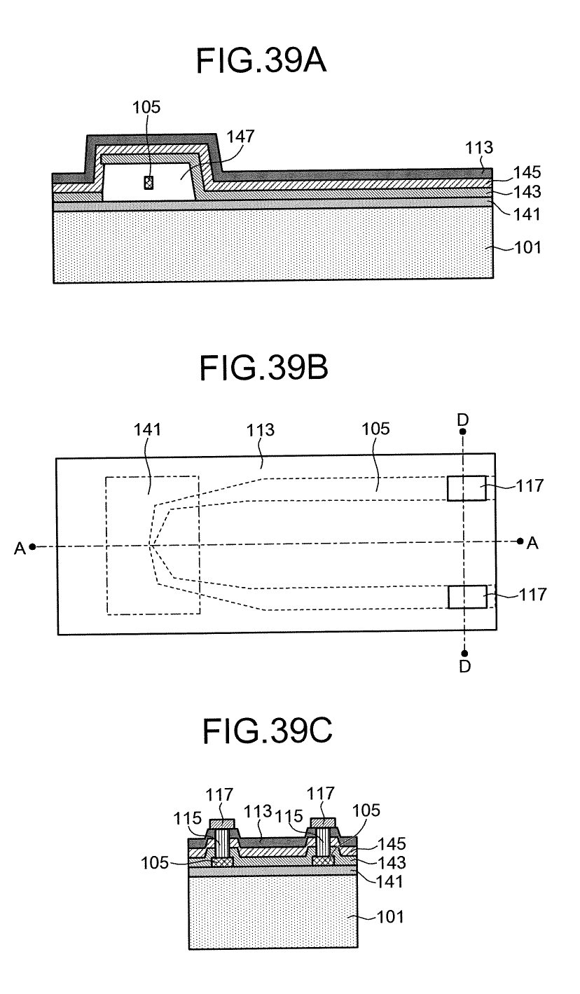

Then, for the purpose of forming an electrode to connect to the electrode layer 105, via holes penetrating from the passivation layer 113 to the electrode layer 105 are formed. FIGS. 38A and 38C are cross-sectional views and FIG. 38B is a top view. As shown in FIGS. 38A to 38C, the contact plugs 115 are formed by plugging a conductive material in the via holes. FIGS. 39A and 39C are cross-sectional views and FIG. 39B is a top view. Then, as shown in FIGS. 39A to 39C, the contact electrodes 117 connecting to the contact plugs 115 are formed. As a result of the above process, the HID lamp 400 shown in FIGS. 24A to 24C is produced.

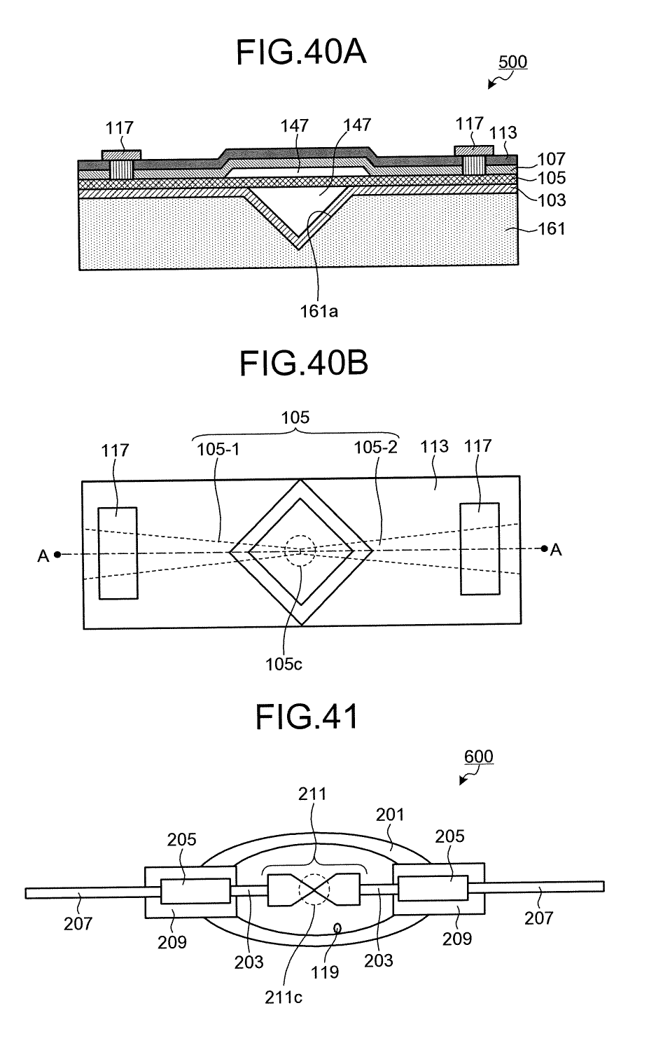

FIGS. 40A and 40B are schematic views of an HID lamp 500 according to a fifth embodiment. FIG. 40B is a top view of the HID lamp 500 shown in FIG. 40A. FIG. 40A is a cross-sectional view along an A-A line in FIG. 40B. Members corresponding to those in the first embodiment are denoted with the same reference numerals, and the same description is not repeated.

The HID lamp 500 in which an impermeable substrate that blocks passage of light is used is another modification of the HID lamp 100. As shown in FIGS. 40A and 40B, the HID lamp 500 includes an impermeable silicon (Si) substrate 161 that blocks passage of light instead of the sapphire substrate 101. The Si substrate 161 has a reentrant portion that is formed by an anisotropic etching process to define a part of the discharge chamber 147. The electrode layer 105 having the narrowed portion 105C bridges the reentrant portion. A slope 161a of the reentrant portion acts as a reflecting layer.

The HID lamp 500, like the HID lamp 100, is easy to operate and has an excellent durability. Moreover, the Si substrate 161, which costs low and is easy to process, enables the HID lamp 500 to be produced in a high productivity and in a low cost.

FIG. 41 is a schematic side view of an HID lamp 600 according to the sixth embodiment. The HID lamp 600 does not employ the laminated structure described above but employs the tube structure like the conventional HID lamp. The HID lamp 600 is an example of a tube-structured HID lamp including the semiconductor electrodes connected to each other and a portion where the electrodes are connected to each other is formed into the narrow portion.

As shown in FIG. 41, the HID lamp 600 includes a chamber 201, an inner lead 203, a lead junction 205, an outer lead 207, a lead supporting unit 209, and an electrode unit 211. The chamber 201 encapsulates a discharge gas, an amalgam 119 as a discharge medium element, and a slight amount of hydrogen gas. The electrode unit 211 forms the narrowed portion 211C by abutting tapered or hemisphere crystal electrodes or tapered or hemisphere electrodes forming a crystal film.

The HID lamp 600, like the HID lamp 100, is easy to operate and has an excellent durability.

According to an aspect of the present invention, the discharge light-emitting device includes at least a pair of electrodes composed of a wide-gap semiconductor having a narrowed portion as a discharge electrode. When the discharge light-emitting device starts operating, the current flows via two pathways, that is, the interelectrode current flowing via the narrowed portion and the discharge current due to direct emission of electrons from a surface of the semiconductor electrode disposed around the narrowed portion to the gas phase. Thus, it is possible to depress an output voltage from the power source, reduce the burden on the discharge light-emitting device, and avoid rising of the starting voltage of the discharge light-emitting device. Therefore, it is possible to provide the discharge light-emitting device with a low starting voltage, easy to operate, and easy to control. In addition, it is possible to form a driving circuit in a simplified way and in a low cost.

Additional advantages and modifications will readily occur to those skilled in the art. Therefore, the invention in its broader aspects is not limited to the specific details and representative embodiments shown and described herein. Accordingly, various modifications may be made without departing from the spirit or scope of the general inventive concept as defined by the appended claims and their equivalents.

What is claimed is:

1. A discharge light-emitting device comprising:
a chamber that encapsulates a discharge gas and has a light permeable portion; and
at least a pair of electrodes that are arranged in the chamber and are made of a wide-gap semiconductor, wherein the pair of electrodes are connected to each other and at least a portion where the electrodes are connected to each other is formed into a narrow portion.

2. The device according to claim 1, wherein
the chamber is defined by a substrate, a sidewall layer formed on the substrate, and a cap layer that is formed on the sidewall layer and faces to the substrate.

3. The device according to claim 2, wherein the cap layer is made of an insulating diamond.

4. The device according to claim 1, wherein the wide-gap semiconductor is a diamond.

5. The device according to claim 2, further comprising:
a reflecting layer that is formed on a surface of the substrate opposite to other surface of the substrate on which the chamber is formed.

6. The device according to claim 1, wherein the chamber is defined by a first insulating diamond layer formed on a substrate, a side wall layer formed on the first insulating diamond layer, and a second insulating diamond layer that is formed on the sidewall layer and faces to the first insulating diamond layer.

7. The device according to claim 6, further comprising:
a reflecting layer that is formed on a surface of the substrate opposite to other surface of the substrate on which the first insulating diamond layer is formed.

8. The device according to claim 1, wherein the light permeable portion is formed into a convex-lens shape.

9. The device according to claim 1, wherein the pair of electrodes are formed into an approximately U-shape.
